(19) United States
(12) Patent Application Publication
(10) Pub. No.: US 2024/0069152 A1
(43) Pub. Date: Feb. 29, 2024

(54) TECHNIQUES FOR MITIGATING INTERFERENCE IN RADAR SIGNALS

(71) Applicant: Symeo GmbH, Neubiberg (DE)

(72) Inventors: Sunrita Poddar, Jamaica Plain, MA (US); Peter Gulden, Erding (DE); Ilker Bayram, Brookline, MA (US)

(21) Appl. No.: 18/272,077

(22) PCT Filed: Jan. 22, 2021
(86) PCT No.: PCT/EP2021/051506

§ 371 Date: Jul. 12, 2023

(51) Int. Cl. G01S 7/02; G01S 7/35; G01S 13/931

(52) U.S. Cl. CPC G01S 7/023; G01S 7/356; G01S 13/931

(57) ABSTRACT

Techniques to improve the detection and mitigation of synchronous and asynchronous interference in radar signals. The corrupted received signals can be processed to reduce the effect of interference, while preserving existing targets. Various can use a two-step approach to (1) detect and mask the corrupted samples, and (2) recover the masked-out samples. The recovery step enforces sparsity of the existing targets and prevents target smearing, which is a common problem after interference mitigation. The sparsity enforcing recovery step can preserve small targets while successfully rejecting interference. The techniques do not require any prior knowledge of the parameters of the interfering radar.

### FIELD OF THE DISCLOSURE

This document pertains generally, but not by way of limitation, to radar systems, and more particularly, to radar systems for use with vehicles.

### BACKGROUND

Radars are present on passenger vehicles to provide a number of safety-related and convenience features, including emergency braking, adaptive cruise control, and automated parking. The scene observed by a radar onboard a vehicle can include a large number of scattering centers—other vehicles, the road surface, objects at the edge of the road, pedestrians, etc. The raw measurements made by the radar are a combination of echoes produced by each of these objects, plus noise. Using various approaches, radars can process the raw measurements and thereby measure a number of quantities pertaining to each target in the scene, such as a range to a target, a radial component of a relative velocity of the target, and an angle that the line-of-sight to the target makes with the radar antenna.

### SUMMARY OF THE DISCLOSURE

This disclosure is directed to techniques that can improve the detection and mitigation of synchronous and asynchronous interference in radar signals. Using various techniques of this disclosure, the corrupted received signals can be processed to reduce the effect of interference, while preserving existing targets. Various techniques of this disclosure are based on a two-step approach to (1) detect and mask the corrupted samples, and (2) recover the masked-out samples. The recovery step enforces sparsity of the existing targets and prevents target smearing, which is a common problem after interference mitigation. The sparsity enforcing recovery step can preserve small targets while successfully rejecting interference. The techniques of this disclosure do not require any prior knowledge of the parameters of the interfering radar.

In some aspects, this disclosure is directed to a radar system having a first transceiver unit, the radar system to mitigate interference caused by a signal transmitted by a second transceiver unit of another radar system, the radar system comprising: the first transceiver unit to: transmit a first signal toward a target; and receive an interference-corrupted combined signal including an echo signal from the target in response to the transmitted first signal and a second signal transmitted by the second transceiver unit, wherein the first transceiver unit and the second transceiver unit have corresponding transmit parameters; a processor to detect synchronous interference in the interference-corrupted combined signal, the processor to: determine a frequency domain representation of the interference-corrupted combined signal; determine a dispersion of a phase characteristic of the representation corresponding to a specified range bin; and based on the dispersion, assign the specified range bin as exhibiting synchronous interference.

In some aspects, this disclosure is directed to a radar system having a first transceiver unit, the radar system to mitigate interference caused by a signal transmitted by a second transceiver unit of another radar system, the radar system comprising: the first transceiver unit to: transmit a first signal toward a target; and receive an interference-corrupted combined signal including an echo signal from the target in response to the transmitted signal and a second signal transmitted by the second transceiver unit, wherein the first transceiver unit and the second transceiver unit have non-identical transmit parameters; a processor to mitigate asynchronous interference in the interference corrupted combined signal, the processor to: determine whether interference is present in a time-domain representation of the interference-corrupted combined signal; suppress samples corresponding to the interference to create a masked signal from a mask (M); and construct a corrected frequency-domain representation (X*) of the interference-corrupted combined signal using the time-domain representation of the interference-corrupted combined signal (Y) and using the mask (M).

In some aspects, this disclosure is directed to a radar system having a first transceiver unit, the radar system to mitigate interference caused by a signal transmitted by a second transceiver unit of another radar system, the radar system comprising: the first transceiver unit to: transmit a first signal toward a target; and receive an interference-corrupted combined signal including an echo signal from the target in response to the transmitted first signal and a second signal transmitted by the second transceiver unit; a processor to detect synchronous interference in the combined signal, the processor to: determine a frequency domain representation of the combined signal; determine a dispersion of a phase characteristic of the representation corresponding to a specified range bin; and based on the dispersion, assign the specified range bin as exhibiting synchronous interference; the processor to mitigate asynchronous interference in the interference corrupted combined signal, the processor to: determine whether interference is present in a time-domain representation of the interference-corrupted combined signal; suppress samples corresponding to the interference to create a masked signal from a mask (M); and construct a corrected frequency-domain representation (X*) of the interference-corrupted combined signal using the time-domain representation of the interference-corrupted combined signal (Y) and using the mask (M).

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a conceptual diagram of an example of a vehicle that includes a radar system that can implement various techniques of this disclosure.

FIG. 2 is a simplified block diagram of an example of a radar system that can implement various techniques of this disclosure.

FIGS. 3A and 3B are examples of range-doppler images obtained from multiple chirps, where FIG. 3B depicts synchronous interference.

FIGS. 4A and 4B are examples of range-doppler images obtained from multiple chirps, where FIG. 4B depicts asynchronous interference.

FIG. 5 is a conceptual diagram illustrating two vehicles that include corresponding radar transceiver units and a target.

FIG. 6 is an example of a range-FFT of a single chirp, the range-FFT depicting a baseline signal of real targets and a corrupted signal with additional fake targets due to synchronous interference.

FIG. 7 is an example of a graph depicting a phase in a range-bin across multiple chirps.

FIG. 8 is a graph depicting a Short Time Fourier Transform (STFT) of a chirp corrupted by asynchronous interference.

FIG. 9 is a graph depicting a STFT of a chirp in the fourth frequency bin corrupted by asynchronous interference.

FIG. 10 is a graph depicting a time domain mask for one frame.

FIGS. 11A and 11B are graphs depicting an example of a frame without asynchronous interference.

FIGS. 12A and 12B are graphs depicting an example of a frame corrupted by asynchronous interference.

FIGS. 13A and 13B are graphs depicting the frame corrupted by asynchronous interference of FIGS. 12A and 12B with a mask applied.

FIGS. 14A and 14B are graphs depicting the frame corrupted by asynchronous interference of FIGS. 12A and 12B after correction using the 2D FFT technique

FIGS. 15A and 15B are graphs depicting the frame corrupted by asynchronous interference of FIGS. 12A and 12B after correction using the 1D FFT technique.

### DETAILED DESCRIPTION

An autonomous vehicle (also referred to as a “self-driving vehicle” or “driverless vehicle”) is a vehicle that is capable of using onboard sensors and/or radar system(s) to sense and react to its environment, thereby allowing the vehicle to respond to the environment without human involvement. The radar system fitted to the vehicle can emit a transmit signal and receive an echo signal reflected back from one or more targets that the radar system is trying to detect, such as a vehicle in the same traffic lane and in front of the vehicle fitted with the radar system.

With an increasing number of radar-equipped vehicles, however, interference between radar systems becomes increasingly likely. The radar system's receiver can detect both the echo signal and any transmit signals from the radar systems of other vehicles, such as vehicles travelling toward the vehicle fitted with the radar system in another traffic lane. These transmit signals from other radar systems can interfere with and corrupt the received echo signal, which can mask the targets that the radar system is trying to detect.

There are two types of automotive radar interference: synchronous interference and asynchronous interference. With synchronous interference, the host transceiver unit and the interferer transceiver unit have corresponding transmit parameters, e.g., substantially identical transmit parameters, such as corresponding bandwidth and slow/fast axis times. With asynchronous interference, the host transceiver unit and the interferer transceiver unit have non-identical transmit parameters, such as different bandwidth and slow/fast axis times.

The present inventors have recognized the need to improve the detection and mitigation of synchronous and asynchronous interference in radar signals. Using various techniques of this disclosure, the corrupted received signals can be processed to reduce the effect of interference, while preserving existing targets. Various techniques of this disclosure are based on a two-step approach to (1) detect and mask the corrupted samples, and (2) recover the masked-out samples. The recovery step enforces sparsity of the existing targets and prevents target smearing, which is a common problem after interference mitigation. The sparsity enforcing recovery step can preserve small targets while successfully rejecting interference. The techniques of this disclosure do not require any prior knowledge of the parameters of the interfering radar.

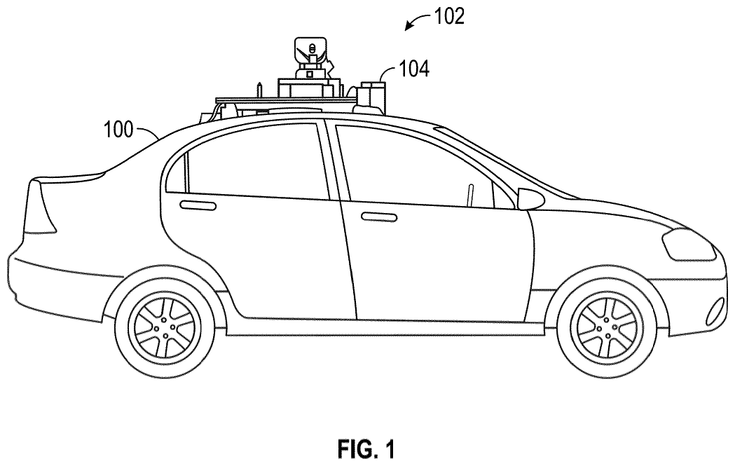

FIG. 1 is a conceptual diagram of an example of a vehicle 100 that includes a radar system 102 that can implement various techniques of this disclosure. The radar system 102 can include two or more radar transceiver units 104 that can be positioned on or within the vehicle 100. Each of the radar transceiver units 104 can transmit a signal and receive an echo signal in response to transmitted signal. By using various techniques described below, the radar system 102 can mitigate interference in radar signals by repairing a received signal so as to accurately detect targets, such as stationary or moving vehicles, buildings, trees, and the like, even in the presence of interference.

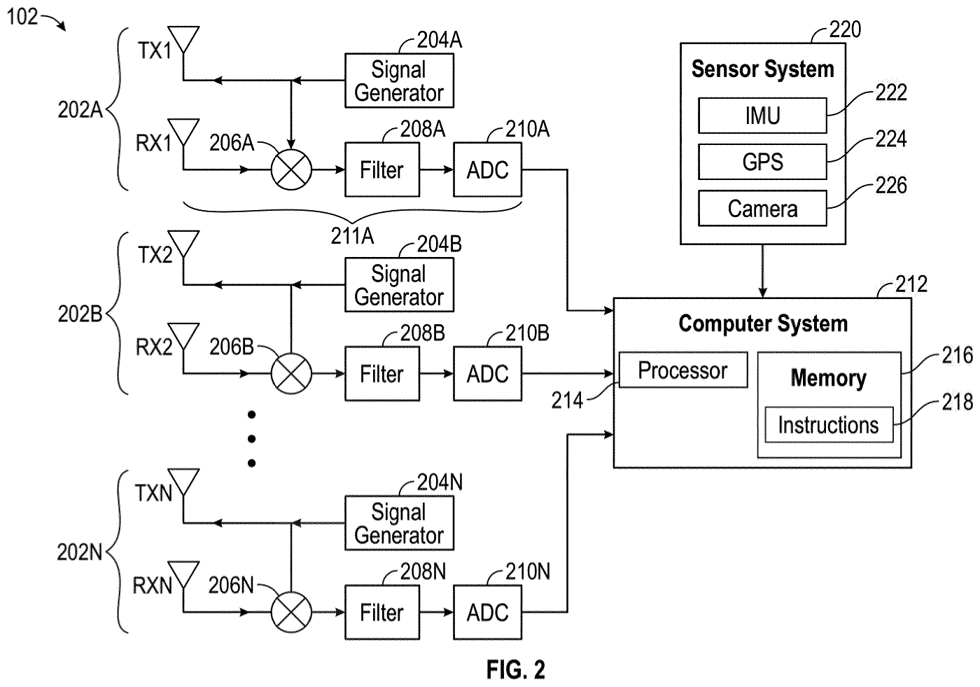

FIG. 2 is a simplified block diagram of an example of a radar system that can implement various techniques of this disclosure. The radar system 102 can include two or more radar transceiver units 202A-202N. In some examples, the radar transceiver units 202A-202N can implement be frequency-modulated continuous wave (FMCW) radar techniques. To determine two-dimensional (2D) motion parameters, at least two radar transceiver units can be used. To determine three-dimensional (3D) motion parameters, at least three radar transceiver units can be used.

The radar transceiver unit 202A can include a signal generator 204A that can be used to generate electromagnetic signals for transmission. The signal generator 204A can include, for example, a frequency synthesizer, a waveform generator, and a master oscillator. In some examples, the signal generator 204A can generate the signal as one or more chirps, where a chirp is a sinusoidal signal having a frequency that increases with time. The signal generator 204A can generate a signal that can be transmitted toward an environment by a transmit antenna TX1. The radar transceiver unit 202A can include one or more receive antennas RX1 to receive an echo signal in response to the transmitted signal.

The transmitted signal and the received echo signal can be applied to corresponding inputs of a mixer 206A to generate an intermediate frequency (IF) signal. The IF signal can be applied to a filter 208A, such a low pass filter, and the filtered signal can be applied to an analog-to-digital converter (ADC) 210A. The antenna(s) RX1, the mixer 206A, the filter 208A, and the ADC 210A can form a receive channel 211A.

As seen in FIG. 2, the radar system 102 can include a second radar transceiver unit 202B. In some examples, the radar system 102 can include more than two radar transceiver units, such as to determine 3D motion parameters. The radar transceiver units 202B-202N can include components similar to those of radar transceiver unit 202A.

The digital output of the ADCs 210A-210N can be applied to a computer system 212. The computer system 212 can include a processor 214, which can include a digital signal processor (DSP), and a memory device 216 coupled to the processor 214 that can store instructions 218 for execution by the processor 214 that specify actions to be taken by the computer system 212.

In some examples, the radar system 102 can include a sensor system 220 that can provide sensor data to the computer system 212. The sensor system 220 can include, for example, one or more of an inertial measurement unit (IMU) 222, a global position system (GPS) 224, and/or a camera 226.

Using various techniques of this disclosure and as described in more detail below, the processor 214 can process the received corrupted radar samples and reduce the interference effects without knowledge of the interfering radar parameters. For example, the processor 214 can detect a time interval for which interference is present and then mask out the corrupted samples (interference detection). Then, the processor 214 can recover the masked-out samples to reduce the distortion of the existing targets. The processor 214 can recover the samples by solving an optimization problem that enforces Fourier-domain sparsity, for example, and preserves existing targets.

The synchronous interference detection techniques of this disclosure will be described first, followed by a description of the asynchronous interference detection and mitigation techniques. With synchronous interference, the interference is not localized in time. The techniques of this disclosure perform detection only of synchronous interference.

As mentioned above, with synchronous interference, the host transceiver unit and the interferer transceiver unit can have corresponding transmit parameters, e.g., substantially identical transmit parameters, such as a corresponding bandwidth and corresponding slow/fast axis times. However, every time the host transceiver unit transmits, the starting phase of a transmitted chirp is different. The techniques of this disclosure can exploit that phase difference to distinguish between a host radar system and an interfering radar system.

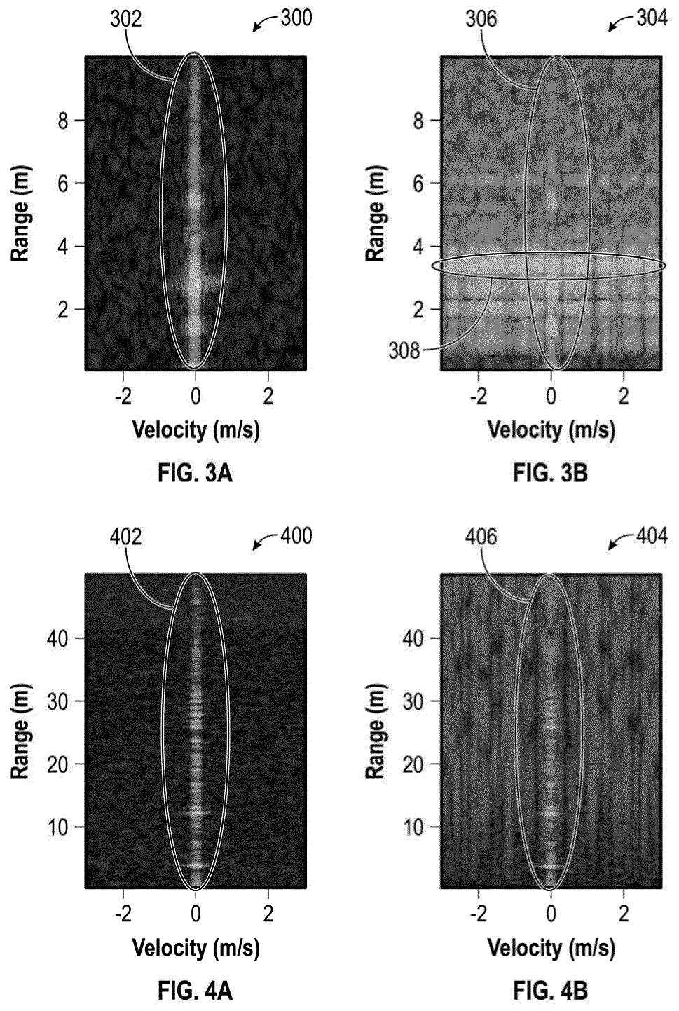

FIGS. 3A and 3B are examples of range-doppler images obtained from multiple chirps, where FIG. 3B depicts synchronous interference. A range-doppler image is a 2-dimensional (2D) Fast Fourier Transform (FFT) performed on the data from one or more of ADCs 210A-210N (of FIG. 2), where the peaks in the frequency spectrum correspond directly to the range of any objects or targets. In FIGS. 3A and 3B, the x-axis represents a velocity in meters/second (m/s) and the y-axis represents the range in meters (m).

The image 300 in FIG. 3A represents a “clean” signal received by a radar transceiver unit of a host radar system, such as the radar transceiver unit 202A of FIG. 2, where the clean signal includes an echo signal from a target in response to a transmitted signal and no interfering signal from any interfering radar transceiver unit. If there is no interference, such as in FIG. 3A, distinct targets, such as shown at 302, can be seen.

The image 304 in FIG. 3B represents a “corrupted” signal having synchronous interference that is received by a radar transceiver unit of a host radar system, such as the radar transceiver unit 202A of FIG. 2, where the corrupted signal includes an echo signal from a target in response to a transmitted signal and an interfering signal from one or more interfering radar transceiver units.

If there is interference, such as in FIG. 3B, distinct targets, such as shown at 306, can be much more difficult to distinguish from the noise in the image 304. The difference in phase noise of the radar transceiver unit of the host radar system and the interfering radar transceiver unit can cause one or more line artifacts, such as the line artifact 308. These artifacts can be detected but can be difficult to remove. Various techniques of this disclosure can use the phase noise of the transceiver units to determine whether synchronous interference is present.

FIGS. 4A and 4B are examples of range-doppler images obtained from multiple chirps, where FIG. 4B depicts asynchronous interference. In FIGS. 4A and 4B, the x-axis represents a velocity in meters/second (m/s) and the y-axis represents the range in meters (m).

The image 400 in FIG. 4A represents a “clean” signal received by a radar transceiver unit of a host radar system, such as the radar transceiver unit 202A of FIG. 2, where the clean signal includes an echo signal from a target in response to a transmitted signal and no interfering signal from any interfering radar transceiver unit. If there is no interference, such as in FIG. 4A, distinct targets, such as shown at 402, can be seen.

The image 404 in FIG. 4B represents a “corrupted” signal having asynchronous interference that is received by a radar transceiver unit of a host radar system, such as the radar transceiver unit 202A of FIG. 2, where the corrupted signal includes an echo signal from a target in response to a transmitted signal and an interfering signal from one or more interfering radar transceiver units. If there is interference, such as in FIG. 4B, distinct targets, such as shown at 406, can be much more difficult to distinguish from the noise in the image 404.

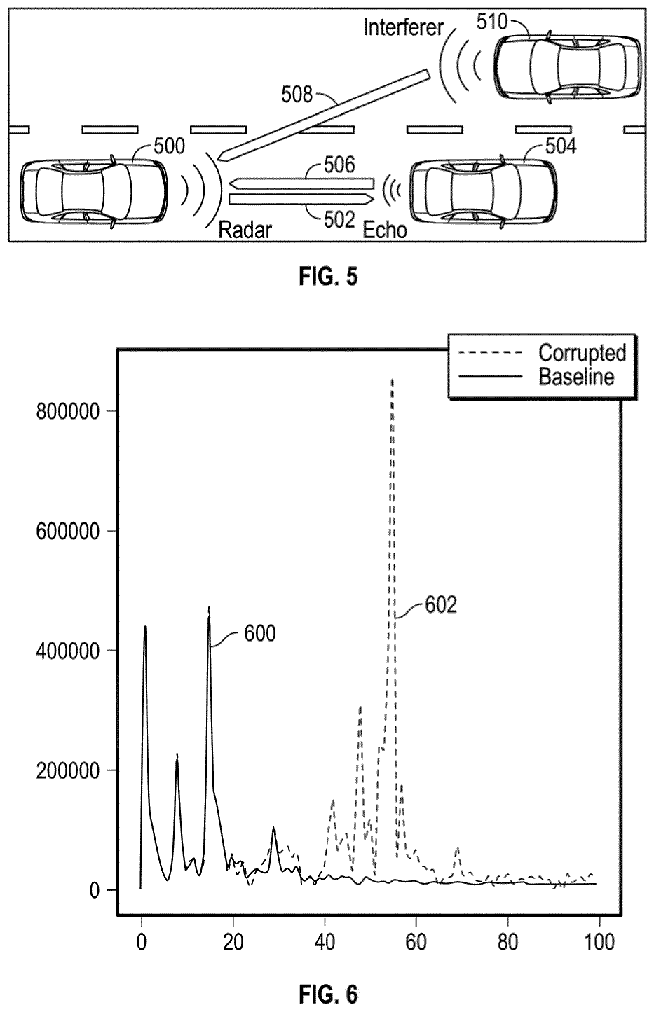

FIG. 5 is a conceptual diagram illustrating two vehicles that include corresponding radar transceiver units and a target. In FIG. 5, a host vehicle 500 can include a radar system, such as the radar system of FIG. 2. The radar system can use various techniques of this disclosure to mitigate interference, e.g., synchronous and/or asynchronous interference, caused by a signal transmitted by a second transceiver unit of another radar system.

The host vehicle 500 can be fitted with a radar system that can include a first transceiver unit, such as the radar transceiver unit 202A of FIG. 2, to transmit a first signal 502 toward a target 504, e.g., a second vehicle, and receive an interference-corrupted combined signal including an echo signal 506 from the target 504 in response to the transmitted first signal 502 and a second signal 508 transmitted by a second transceiver unit, such as fitted to a third vehicle 510. The interference-corrupted combined signal can persist over multiple chirps.

Using various techniques and as described in more detail below, to detect synchronous interference in the interference-corrupted combined signal, a processor, such as the processor 214 of FIG. 2, can determine a frequency domain representation, such as an FFT, of the interference-corrupted combined signal, determine a dispersion, such as a standard deviation, variance, interquartile range, of a phase characteristic of the representation corresponding to a specified range bin, and based on the dispersion, assign the specified range bin as exhibiting synchronous interference.

FIG. 6 is an example of a range-FFT of a single chirp, the range-FFT depicting a baseline signal of real targets and a corrupted signal with additional fake targets due to synchronous interference. The x-axis represents the range bin number and the y-axis represents the magnitude of the range-FFT.

If there is no synchronous interference, only the baseline signals 600 (real targets) are present. However, if synchronous interference is present, additional fake targets will also appear in the corrupted signal 602. A processor, such as the processor 214 of FIG. 2, can determine a frequency domain representation of the interference-corrupted signal 602. In some examples, the frequency domain representation can include a discrete Fourier transform, such as obtained by an FFT. FIG. 6 graphically depicts an example of a frequency domain representation of the interference-corrupted combined signal.

To distinguish between the real target and the fake target, the synchronous interference techniques of this disclosure can utilize how the phase changes across different chirps.

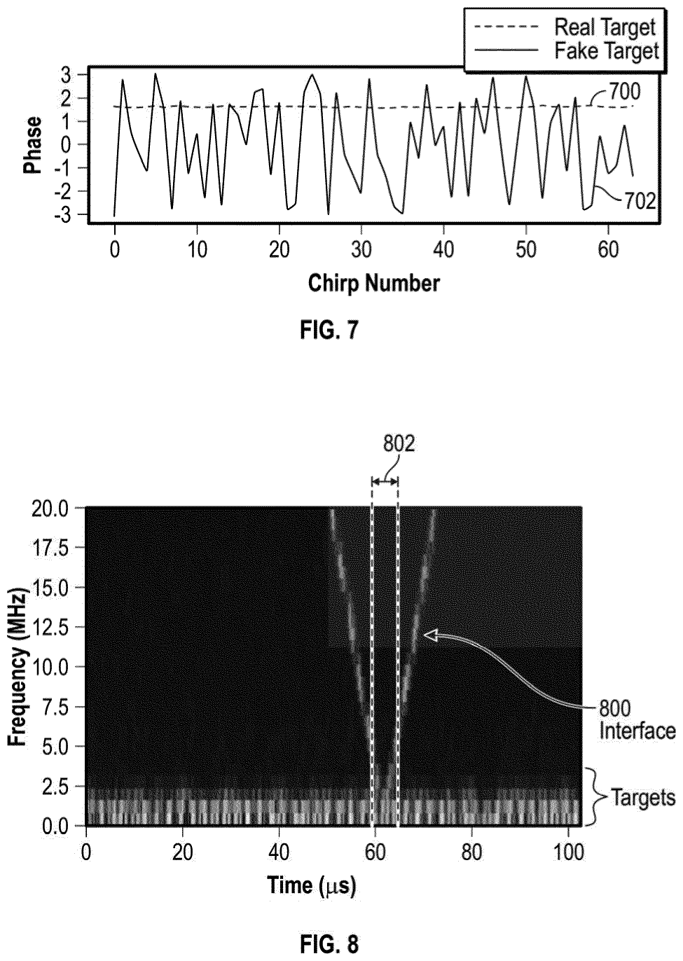

FIG. 7 is an example of a graph depicting a phase in a range-bin across multiple chirps. The x-axis represents the chirp number, and the y-axis represents the phase in radians. In FIG. 7, each range-bin of the baseline signal 600 (real target) of FIG. 6 and the corrupted signal 602 (fake target) of FIG. 6 have been phase-unwrapped. The graph can be generated by the processor, such as the processor 214 of FIG. 2, by taking the range-FFT of all chirps and looking at a particular range-bin for each of the range-FFTs.

As seen in FIG. 7, the phase remains relatively constant across multiple chirps for the real target 700 but the phase changes across multiple chirps for the fake target 702. For static targets, a derivative across chirps is zero and for moving targets, the derivative across chirps will be constant.

The processor can determine a dispersion, such as variance, standard deviation, and interquartile range, of a phase characteristic, such as a derivative, of the representation corresponding to a specified range bin. For example, the processor 214 of FIG. 2 can determine a standard deviation of a derivative of the phase in each range-bin.

A large standard deviation of a derivative of a specified range bin can imply a fake target and can therefore be used for detecting synchronous interference. Thus, if the standard deviation of the derivative of a specified range bin meets some criterion, the processor can assign the specified range bin as exhibiting synchronous interference. For example, the processor can compare the dispersion, such as the standard deviation, to a threshold.

In some examples, the processor can determine multiple metrics, such as a dispersion and a central tendency, e.g., average, mean, median, mode, of the phase characteristic, such as a derivative, of the representation corresponding to a specified range bin. Using multiple metrics and using a corresponding criterion to evaluate each, such a comparing to threshold, can help improve confidence.

In some examples, the processor can determine multiple dispersions of the phase characteristic of the representation corresponding to multiple range bins.

As mentioned above, in addition to detecting synchronous interference, this disclosure describes techniques to detect asynchronous interference between a host transceiver unit and an interferer transceiver unit, such as where the first transceiver unit and the second transceiver unit have non-identical transmit parameters. A radar system, such as the radar system 102 of FIG. 2, can implement the techniques to detect synchronous interference and/or to detect and mitigate asynchronous interference.

To detect asynchronous interference in the interference-corrupted combined signal and as described in more detail below, a processor, such as the processor 214 of FIG. 2, can determine whether interference is present in a time-domain representation of the interference-corrupted combined signal, suppress samples corresponding to the interference to create a masked signal from a mask (M), and construct a corrected frequency-domain representation of the interference-corrupted combined signal using the time-domain representation of the interference-corrupted combined signal (Y) and using the mask (M). As such, the asynchronous detection and mitigation techniques can be considered a two-step process: 1) interference detection and masking of corrupted samples, and 2) recovery of masked samples.

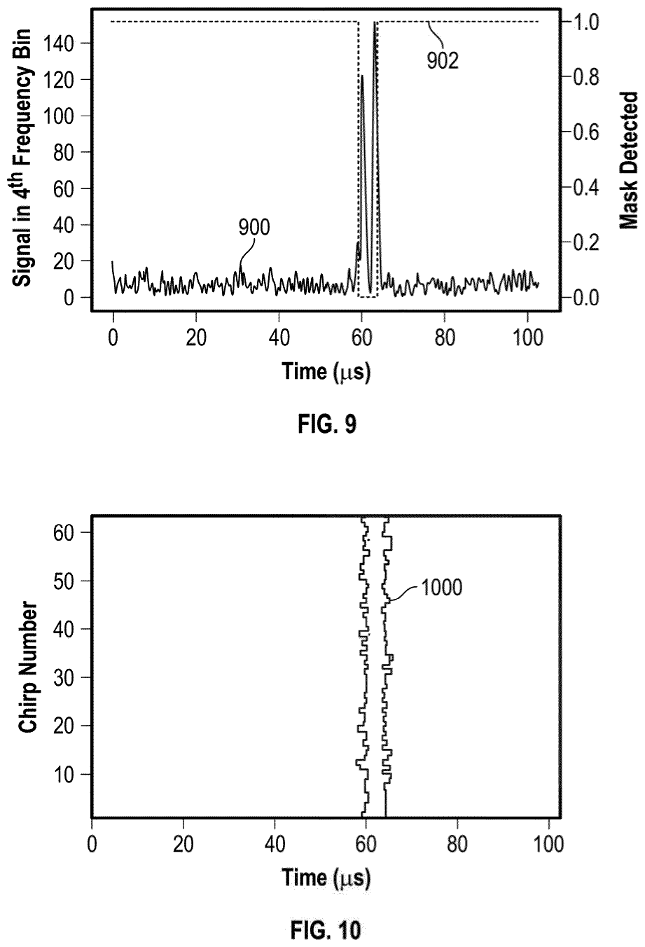

To detect asynchronous interference caused by a signal transmitted by a second transceiver unit of another radar system, a processor, such as the processor 214 of FIG. 2, of a first radar system can first determine whether interference is present in the received signal. For example, as described below with respect to FIGS. 8 and 9, based on an amplitude of the frequency-domain representation of the interference-corrupted combined signal, such as a Short Time Fourier Transform (STFT) of a chirp corrupted by asynchronous interference, the processor can assign a time interval as exhibiting asynchronous interference.

FIG. 8 is a graph depicting a Short Time Fourier Transform (STFT) of a chirp corrupted by asynchronous interference. The x-axis represents time in microseconds (μs) represents the frequency of the chirp in megahertz (MHz). Interference 800 from an interfering radar, such as a radar system positioned on the on-coming vehicle 510 of FIG. 5, has a characteristic V-shape, as shown in FIG. 8. A time interval 802 depicts where the interfering radar system corrupts any targets, such as the vehicle 504 in FIG. 5.

To detect asynchronous interference caused by a signal transmitted by a second transceiver unit of another radar system, a processor, such as the processor 214 of FIG. 2, of a first radar system can determine the STFT of each chirp for any receive channel of the radar system. The processor can then detect a time interval where interference corrupts the target, as shown in FIG. 9.

Assume that there is interest in targets at locations to about 50 m from the host transceiver unit. The processor can determine the time interval when the interfering radar corrupts the targets of interest using the fourth frequency bin in FIG. 9.

FIG. 9 is a graph depicting a STFT of a chirp in the fourth frequency bin corrupted by asynchronous interference. The x-axis represents time in microseconds. The magnitude of the STFT in the fourth frequency bin is shown at 900. A detected mask based on thresholding the STFT values is shown at 902, where a value of 1 represents no interference and a value of 0 represents detection of interference.

As mentioned above, the processor can determine the time interval when the interfering radar corrupts the target. For example, the processor can compare the amplitude of the STFT of the corrupted signal 900 to a criterion. As an example, the processor can compare the amplitude of the frequency of the corrupted signal 900 to a central tendency, such as multiple of a central tendency, e.g., two times a median value of the amplitude.

As seen in FIG. 9, the amplitude of the corrupted signal 900 spikes to over 100, which meets the criterion, e.g., meeting or exceeding two times a median value of the amplitude, at around 60 μs. Based the amplitude meeting the criterion, the processor can automatically detect a mask 902 at around 60 μs.

The graphs in FIGS. 8 and 9 represent one chirp. The processor can repeat the process of detection for every chirp in a frame, and then determine a mask, such as shown in FIG. 10.

FIG. 10 is a graph depicting a time domain mask for one frame. The x-axis represents time in microseconds and the y-axis represents the chirp number. As seen in FIG. 10, the processor has determined a mask (M) 1000 for the chirps in the frame. Next, the processor can suppress samples corresponding to the interference 800 of FIG. 8 to create a masked signal from the mask (M) of FIG. 9.

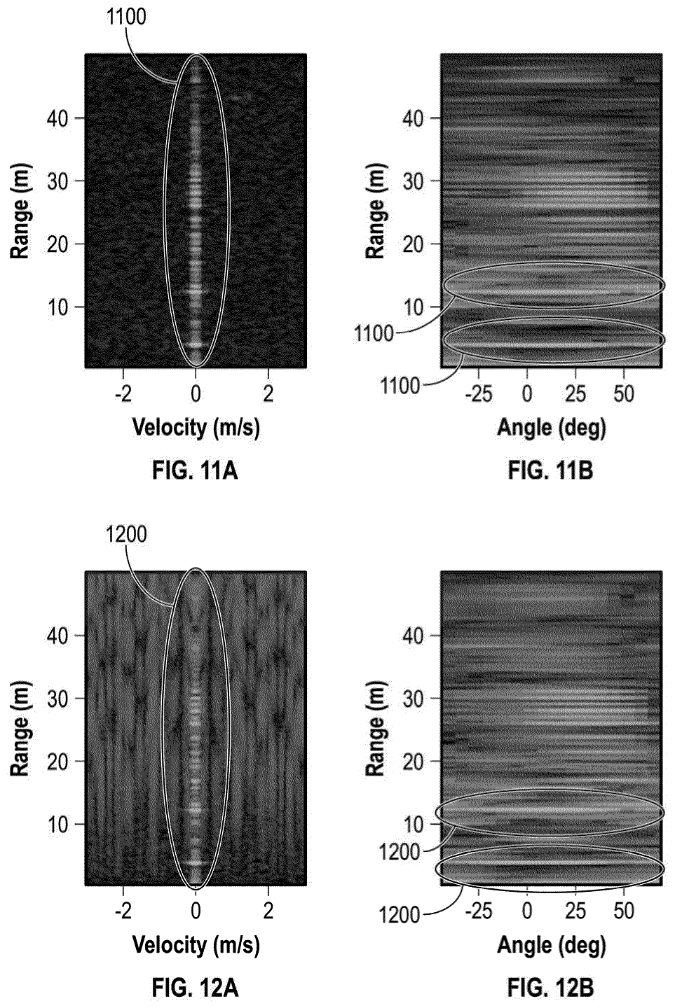

FIGS. 11A and 11B are graphs depicting an example of a frame without asynchronous interference (a “clean” signal). In FIG. 11A, the x-axis represents velocity in meters/second (m/s) and the y-axis represents the range in meters. In FIG. 11B, the x-axis represents angle in degrees and the y-axis represents the range in meters.

The signal-to-noise ratio (SNR) is 18.27 decibels (dB) in the example shown in FIGS. 11A and 11B. The targets 1100 are shown clearly in FIGS. 11A and 11B.

As shown in FIG. 2, the radar system 102 can include two or more radar transceiver units 202A-202N, with each transceiver unit having a receive channel, such as the receive channel 211A of transceiver unit 202A. A processor can generate a range-velocity image per receive channel (each channel having a different angular field-of-view) and then put them together to generate a range-angle image. In this manner, the processor can generate a 3D radar image cube, where each slice is a range-velocity image.

FIGS. 12A and 12B are graphs depicting an example of a frame corrupted by asynchronous interference. In FIG. 12A, the x-axis represents velocity in meters/second (m/s) and the y-axis represents the range in meters. In FIG. 12B, the x-axis represents angle in degrees and the y-axis represents the range in meters. The SNR is 10.49 dB, and the signal-to-interference ratio (SIR) is 8.233 dB in the example shown in FIGS. 12A and 12B. Some targets 1200 are obscured in FIGS. 12A and 12B. In particular, the range-velocity image of FIG. 12A is significantly corrupted, with the targets 1200 under the interference floor and barely visible beyond a range of about 30 m.

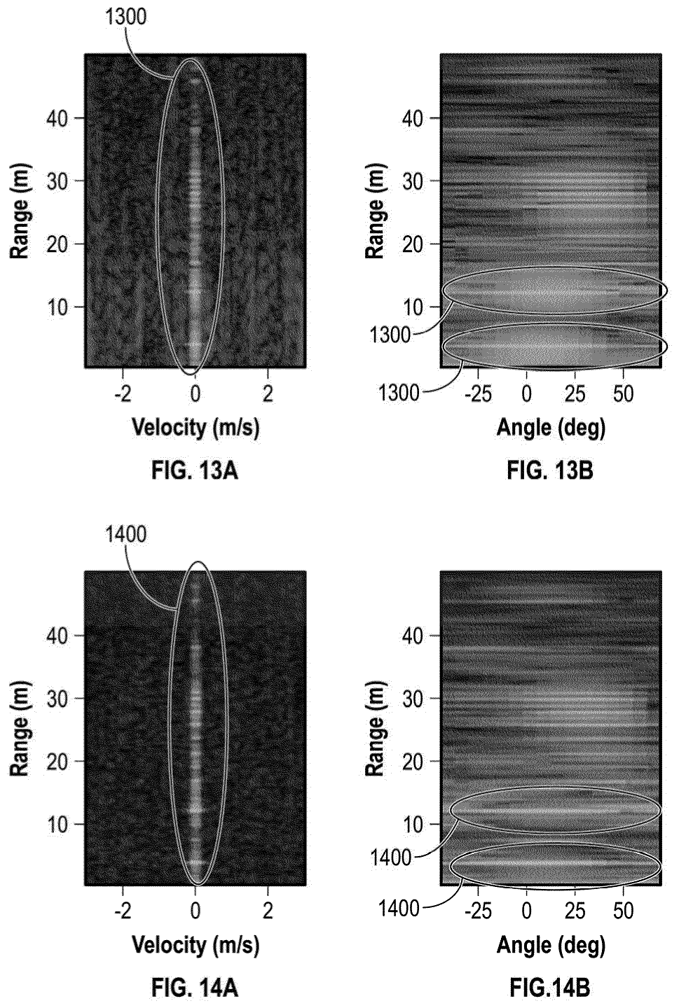

FIGS. 13A and 13B are graphs depicting the frame corrupted by asynchronous interference of FIGS. 12A and 12B with a mask applied. In FIG. 13A, the x-axis represents velocity in meters/second (m/s) and the y-axis represents the range in meters. In FIG. 13B, the x-axis represents angle in degrees and the y-axis represents the range in meters. The SNR is 9.216 dB, and the signal-to-interference ratio (SIR) is 7.866 dB in the example shown in FIGS. 13A and 13B.

The masked signal shown in FIGS. 13A and 13B can be generated by the processor applying a mask, such as the mask 1000 of FIG. 10 to a corrupted signal, such as in FIGS. 12A and 12B. For example, the processor can assign zero values or downweighted values (e.g., values that have been reduced, such as by a scaling factor) in the time domain to the samples corresponding to the interference. In this manner, the processor can suppress samples corresponding to the interference to create a masked signal from a mask (M). However, as seen in FIGS. 13A and 13B, applying the mask can distort or smear the target 1300, particularly in the range-angle image of FIG. 13B. The SNR has decreased after the application of the mask. The masking can reduce the range resolution of the host radar system.

Now that a particular time interval of the detected signal has been masked out, in the second step, the processor can recover the missing or masked samples to repair the detected signal, which can improve the range resolution. To recover the masked samples, the processor, such as the processor 214 of FIG. 2, can execute instructions to solve an optimization problem. There are two implementations: 1) a range-doppler image-based implementation and 2) a range-FFT implementation.

In the range-doppler image-based implementation, the processor can solve Equation 1 below:

$${X}^{*} = arg {min}_{X} {‖ Mo ( {F}_{2}^{- 1} X - Y ) ‖}^{2} + λ {‖ X ‖}_{1}$$

where X* represents the recovered range-doppler image (a corrected frequency-domain representation), M represents the two-dimensional (2D) mask, X represents the recovered range-doppler image (a masked candidate corrected frequency-domain representation of the interference-corrupted combined signal), Y represents the interference-corrupted corrected time-domain representation of the combined signal, and the last term λ∥X∥₁ represents a sparsity regularizer term that enforces the sparsity of the range-doppler image, where a sparse signal has many zero or near-zero values.

Using Equation 1, the processor can construct a corrected frequency-domain representation (X*) of the interference-corrupted combined signal using the time-domain representation of the interference-corrupted combined signal (Y) and using the mask (M).

To solve the optimization problem of Equation 1, the processor can obtain a 2D-mask M using the detection step describe above. Next, the processor can perform an initialization:

X₀=M∘Y, β=0.001, λ=0.01

Next, the processor can perform the following iterations to recover X:

$$for n = 1 : {N}_{outer}$$

$${Q}_{ij} = \frac{1}{{M}_{ij} + β}$$

$$for m = 1 : {N}_{inner}$$

$$X = {F}_{2} ( {QoF}_{2}^{- 1} ( {X}_{0} + β Z ) )$$

$${Z}_{ij} = \{ \begin{matrix}0 , & if \vert {X}_{ij} \vert < \frac{λ}{β} \\ {X}_{ij} - \frac{λ}{β} , & otherwise\end{matrix}$$

$$β = β \times 10$$

Examples of minimum values can include Nₒᵤₜₑᵣ=2, Nᵢₙₙₑᵣ=2.

Below is an intuitive explanation of the equations that describe how the processor solves the optimization problem of Equation 1.

The initial guess or initialization of the algorithm is the range doppler image where the corrupted time domain samples have been masked out (such as set to zero or otherwise downweighted), where X₀ refers to the initial guess, M is the mask that operates on time-domain samples, and X* is the recovered range-doppler image. The objective function in the optimization problem has two terms:
1. A data consistency term to ensure that if processor performs the inverse 2D FFT of the recovered range-doppler image (X), then the uncorrupted samples should be similar to the measured time-domain samples (Y). The selection of uncorrupted samples is done using the mask M. This term preserves the uncorrupted samples.
2. A regularization term λ∥X∥₁ to ensure that the recovered range-doppler image (X) is sparse. This term aids the recovery of the corrupted samples that have been masked.
   Solving Equation 1 to estimate the masked-out samples finds a balance between sparsity of X* and similarity to Y. This is controlled by the parameter λ, which can be kept constant across datasets.

The approach to solving the optimization problem is called ‘variable splitting’ which results in two variables ‘Z’ and ‘X’. These variables can be solved iteratively. Initially Z=X₀. Z can be a sparse approximation of X, obtained by setting small values in X to 0, and shrinking larger values by a constant. This process is called soft-thresholding. The processor can compute the variable X by a weighted sum of the masked data X₀ and the current sparse approximation Z. As the processor performs more iterations, the confidence in the estimate of Z increases, and the processor can apply greater weightage β to Z than our initial guess X₀.

Because the sparsity is in the 2D FFT domain and the masking is in the time domain, the processor moves back and forth between the two domains. There is an inner loop and an outer loop. When the processor finishes a few iterations of the inner loop, the processor can increase β in the outer loop. The elements of matrix Q can be determined by the current value of β and the matrix M. The matrix M can be composed of zeros or downweighted values (representing corrupted samples) and ones (representing uncorrupted samples). The variable Q adjusts for the weighting factor applied to a time-domain sample depending on whether it was zeroed out or not by M.

The formulation of Equation 1 solves for the entire range-doppler (alternatively called range-velocity) image at once. In this formulation, the processor should wait for all the chirp returns to be measured before the process can recover the entire frame. The optimization problem can be solved iteratively, as shown above. The 2D FFT can be computationally intense, however.

As mentioned above, in addition to the range-doppler image-based implementation described above, a range-FFT implementation can be used. In the range-FFT implementation, the processor can solve Equation 2 below:

$${x}^{*} = arg {min}_{x} {‖ mo ( {F}^{- 1} x - y ) ‖}^{2} + λ {‖ x ‖}_{1}$$

where x* represents the recovered range-FFT signal (a corrected frequency-domain representation), m represents the one-dimensional (1D) mask, x represents the recovered range-FFT signal (a candidate corrected frequency-domain representation of the interference-corrupted combined signal), y represents the time-domain representation of the interference-corrupted combined signal, and the last term λ∥x∥₁ represents a sparsity regularizer term that enforces the sparsity of the range-doppler image, where a sparse signal has many zero or near-zero values.

The formulation of Equation 2 solves for each chirp independently. As such, the radar system does not need to wait for all the data from a particular frame to be measured before performing the processing. In this formulation, only one-dimensional FFTs are required. The sparsity assumption is on the range-FFT of each chirp. The processor can solve the optimization problem like the range-doppler image based implementation described above, except that in Equation 2, the processor can now solve for vectors instead of matrices, and the 2D FFTs can be replaced by 1D FFTs.

Regarding computational complexity, in some examples, asynchronous detection and masking can utilize one STFT per chirp for any one receive channel. For interference mitigation, the computational complexity can depend on whether the radar system uses the range-doppler image-based implementation or the range-FFT implementation.

For the range-doppler image-based implementation (using Equation 1), the processor can use eight 2D-FFTs per frame per receive channel. In contrast, the range-FFT implementation allows for independent recovery of chirps, does not need to process uncorrupted chirps, and has a lower computational complexity (1D FFTs used).

As mentioned above, a processor can generate a range-velocity image per receive channel (each channel having a different angular field-of-view) and then put them together to generate a range-angle image. To reduce the number of iterations needed to solve the optimization problems of either Equation 1 or Equation 2, the processor of the radar system, such as the processor 214 of FIG. 2, can initialize some of the receive channels using information from one or more of the other receive channels. In other words, the processor can use the solution to either of the optimization problems of either Equation 1 or Equation 2 in one receive channel as an initial guess for one or more of the other receive channels because they are correlated. That is, the processor can initialize a candidate-corrected frequency-domain representation (X) of the interference-corrupted combined signal of a first receive channel using a signal from a second receive channel. In this manner, the solutions in those other receive channels can converge more quickly, thereby reducing the number of FFTs that the processor needs to perform.

FIGS. 14A and 14B are graphs depicting the frame corrupted by asynchronous interference of FIGS. 12A and 12B after correction using the 2D FFT technique. In FIG. 14A, the x-axis represents velocity in meters/second (m/s) and the y-axis represents the range in meters. In FIG. 14B, the x-axis represents angle in degrees and the y-axis represents the range in meters.

Using the techniques described above with respect to Equation 1 and using 2D FFTs, the processor can recover the missing or masked samples to repair the detected signal, which can improve the range resolution. As seen in FIGS. 14A and 14B, the resolution of the targets 1400 is improved.

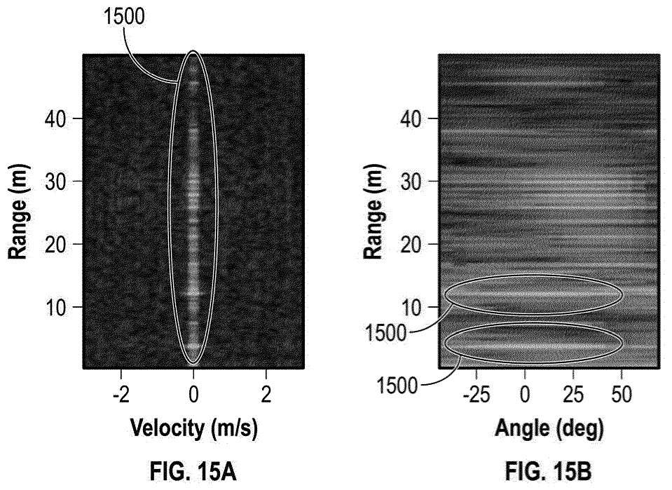

FIGS. 15A and 15B are graphs depicting the frame corrupted by asynchronous interference of FIGS. 12A and 12B after correction using the 1D FFT technique. In FIG. 15A, the x-axis represents velocity in meters/second (m/s) and the y-axis represents the range in meters. In FIG. 15B, the x-axis represents angle in degrees and the y-axis represents the range in meters.

Using the techniques described above with respect to Equation 2 and using 1D FFTs, the processor can recover the missing or masked samples to repair the detected signal, which can improve the range resolution. As seen in FIGS. 15A and 15B, the resolution of the targets 1500 is improved.

### Various Notes

Each of the non-limiting aspects or examples described herein may stand on its own or may be combined in various permutations or combinations with one or more of the other examples.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact discs and digital video discs), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

1. A radar system having a first transceiver unit, the radar system to mitigate interference caused by a signal transmitted by a second transceiver unit of another radar system, the radar system comprising:
the first transceiver unit to: transmit a first signal toward a target; and
receive an interference-corrupted combined signal including an echo signal from the target in response to the transmitted first signal and a second signal transmitted by the second transceiver unit, wherein the first transceiver unit and the second transceiver unit have corresponding transmit parameters; and
a processor to detect synchronous interference in the interference-corrupted combined signal, the processor to:
determine a frequency domain representation of the interference-corrupted combined signal;
determine a dispersion of a phase characteristic of the representation corresponding to a specified range bin; and
based on the dispersion, assign the specified range bin as exhibiting synchronous interference.

2. The radar system of claim 1, wherein to, based on the dispersion, assign the specified range bin as exhibiting synchronous interference, the processor is further to:
compare the dispersion to a threshold.

3. The radar system of claim 1, the processor further to:
determine multiple metrics of the phase characteristic of the representation corresponding to a specified range bin.

4. The radar system of claim 1, the processor further to:
determine multiple dispersions of the phase characteristic of the representation corresponding to multiple range bins.

5. The radar system of claim 1, wherein the dispersion includes a standard deviation.

6. The radar system of claim 1, wherein the frequency domain representation includes a discrete Fourier Transform representation (FFT).

7. A radar system having a first transceiver unit, the radar system to mitigate interference caused by a signal transmitted by a second transceiver unit of another radar system, the radar system comprising:
the first transceiver unit to:
transmit a first signal toward a target; and
receive an interference-corrupted combined signal including an echo signal from the target in response to the transmitted signal and a second signal transmitted by the second transceiver unit, wherein the first transceiver unit and the second transceiver unit have non-identical transmit parameters; and
a processor to mitigate asynchronous interference in the interference corrupted combined signal, the processor to:
determine whether interference is present in a time-domain representation of the interference-corrupted combined signal;
suppress samples corresponding to the interference to create a masked signal from a mask (M); and
construct a corrected frequency-domain representation (X*) of the interference-corrupted combined signal using the time-domain representation of the interference-corrupted combined signal (Y) and using the mask (M).

8. The radar system of claim 7, wherein to determine whether the interference is present in the time-domain representation of the combined signal, the processor further to:
based on an amplitude of the frequency-domain representation of the combined signal, assign a time interval as exhibiting asynchronous interference.

9. The radar system of claim 7, wherein to suppress samples corresponding to the interference to create a masked signal, the processor further to:
assign zero values in the time domain to the samples corresponding to the interference.

10. The radar system of claim 7, wherein to construct a corrected frequency-domain representation (X*) of the interference-corrupted combined signal using the time-domain representation of the interference-corrupted combined signal (Y) and using the mask (M), the processor further to:
minimize a difference between a masked candidate corrected frequency-domain representation (X) of the interference-corrupted combined signal and the masked interference-corrupted corrected time-domain representation of the combined signal (Y) by applying a sparsity regularizer.

11. The radar system of claim 7, wherein to suppress samples corresponding to the interference to create a masked signal, the processor further to:
downweight values in the time domain to the samples corresponding to the interference.

12. The radar system of claim 7, the processor to perform a 2-dimensional Fast Fourier Transform.

13. The radar system of claim 7, the processor to perform a 1-dimensional Fast Fourier Transform.

14. The radar system of claim 7, wherein the first transceiver unit includes a first receive channel and a second receive channel, the processor further to:
initialize a candidate-corrected frequency-domain representation (X) of the interference-corrupted combined signal of the first receive channel using a signal from the second receive channel.

15. A radar system having a first transceiver unit, the radar system to mitigate interference caused by a signal transmitted by a second transceiver unit of another radar system, the radar system comprising:
the first transceiver unit to:
transmit a first signal toward a target; and
receive an interference-corrupted combined signal including an echo signal from the target in response to the transmitted first signal and a second signal transmitted by the second transceiver unit; and
a processor to detect synchronous interference in the combined signal, the processor to:
determine a frequency domain representation of the combined signal;
determine a dispersion of a phase characteristic of the representation corresponding to a specified range bin; and
based on the dispersion, assign the specified range bin as exhibiting synchronous interference;
the processor to mitigate asynchronous interference in the interference corrupted combined signal, the processor to:
determine whether interference is present in a time-domain representation of the interference-corrupted combined signal;
suppress samples corresponding to the interference to create a masked signal from a mask (M); and
construct a corrected frequency-domain representation (X*) of the interference-corrupted combined signal using the time-domain representation of the interference-corrupted combined signal (Y) and using the mask (M).

16. The radar system of claim 15, wherein to, based on the dispersion, assign the specified range bin as exhibiting synchronous interference, the processor is further to:
compare the dispersion to a threshold.

17. The radar system of claim 15, wherein the dispersion includes a standard deviation.

18. The radar system of claim 15, wherein to determine whether the interference is present in the time-domain representation of the combined signal, the processor further to:
based on an amplitude of the frequency-domain representation of the combined signal, assign a time interval as exhibiting asynchronous interference.

19. The radar system of claim 15, wherein to suppress samples corresponding to the interference to create a masked signal, the processor further to:
assign zero values or downweighted values in the time domain to the samples corresponding to the interference.

20. The radar system of claim 15, wherein to construct a corrected frequency-domain representation (X*) of the interference-corrupted combined signal using the time-domain representation of the interference-corrupted combined signal (Y) and using the mask (M), the processor further to:
minimize a difference between a masked candidate corrected frequency-domain representation (X) of the interference-corrupted combined signal and the masked interference-corrupted corrected time-domain representation of the combined signal (Y) by applying a sparsity regularizer.
